(19) United States
(12) Patent Application Publication
(10) Pub. No.: US 2002/0041325 A1
(43) Pub. Date: Apr. 11, 2002

(54) Interaction configuration

(76) Inventor: Christoph Maggioni, Berlin (DE)

Correspondence Address: LERNER AND GREENBERG, P.A., Post Office Box 2480, Hollywood, FL, 33022-2480, US

(21) Appl. No.: 09/953,728

(22) Filed: Sep. 17, 2001

Related U.S. Application Data
(63) Continuation of application No. PCT/DE00/00637, filed on Mar. 1, 2000.

(30) Foreign Application Priority Data
Mar. 17, 1999 (DE) 199 11 985.6

(51) Int. Cl. H04N 7/14

(52) U.S. Cl. 348/14.16; 348/14.01

(57) ABSTRACT

An interaction configuration is specified which has a projection surface which is disposed in such a way that it is visible to a user. Furthermore, a camera is provided which is disposed in the projection surface. In this case, the user and the addressee can be projected at each other in a more natural manner, in particular, the interaction configuration provides eye-to-eye contact.

### CROSS-REFERENCE TO RELATED APPLICATION

This application is a continuation of copending International Application No. PCT/DE00/00637, filed Mar. 1, 2000, which designated the United States.

### BACKGROUND OF THE INVENTION

1. Field of the Invention

The invention relates to an interaction configuration for teleconferencing between two parties. U.S. Pat. No. 5,528,263 and Published, Non-Prosecuted German Patent Application DE 197 08 240 A1 disclose a so-called virtual touch screen. With the recording of an interaction component, e.g. a hand or a pointer, together with an interaction surface onto which preferably a graphical user interface is projected, it is possible to interact directly on the graphical user interface; the above-described division between display of the user interface and touch screen is obviated.

A flat loudspeaker (panel loudspeaker) is disclosed in the reference titled “Product Description: Panel Loudspeakers: The Resonant Poster—Decorative, Light and Effective” by Siemens AG, 1999.

A miniature camera (also so-called a “keyhole” camera) having a very small objective diameter of e.g. 1 mm is also known and can be procured in specialized electronics shops.

By way of example, when two users communicate via a virtual touch screen, it is disadvantageous that when the face of the user is projected onto the user interface, the observing user watches the user interface and his face is not recorded along his viewing direction. As a result, the gaze of the participant e.g. in video telephony, appears not to be directed at the addressee, rather the participant looks past the addressee.

The reference titled “Two-Way Desk-Top Display System” IBM Technical Disclosure Bulletin, vol. 36, no. 09b, September 1993, pages 359-360, discloses a camera/projection screen unit for communication between users, the configuration of the camera behind the projection screen enabling communication with “eye contact”.

### SUMMARY OF THE INVENTION

It is accordingly an object of the invention to provide an interaction configuration which overcomes the above-mentioned disadvantages of the prior art devices of this general type, which, when observing a display surface, a user can be recorded in such a way as if he were looking directly into a camera, the intention being to avoid problems when recording the user through the projection surface.

With the foregoing and other objects in view there is provided, in accordance with the invention, an interaction configuration. The interaction configuration contains a projection surface disposed such that the projection surface is visible to a user, a camera for recording an image of the user disposed in the projection surface, and a processor unit set up for detecting and recording a movement or a lingering of an interaction component on the projection surface. The movement or the lingering of the interaction component is interpreted as an input pointer.

In order to achieve the object, the interaction configuration is specified to have a projection surface that is disposed in such a way that it is visible to a user. Furthermore, a camera is provided which is disposed in the projection surface.

An above-mentioned miniature camera having a small objective diameter is suitable for this purpose. A hole of the order of magnitude of the objective diameter is advantageously provided in the projection surface. The camera is disposed behind this hole. Given the small objective diameter, such a small hole in the projection surface is not noticeable in a disturbing way. As a result, the face of the user observing the projection surface can be recorded head on. Precisely in the case of a service such as video telephony, in which a face of the addressee is displayed within the projection surface, the addressee is given the impression that the user is looking him straight in the eye. The annoying effect whereby the participants in the video telephony look past one another is avoided as a result.

One development consists in a dark spot encompassing at least the objective of the camera being projected onto the camera location. This ensures good quality in the identification of the participant.

It shall be noted here that other objects disposed in front of the camera can also be recorded in addition to the participant. Furthermore, it is also possible to dispose a plurality of (miniature) cameras in the projection surface, with the result that, depending on the gaze of the observer, the camera that best captures the gaze is used for recording.

One development consists in a processor unit being provided which is set up in such a way that a (graphical) user interface can be displayed on the projection surface (also: interaction surface). In particular, it is possible to provide a further camera that can be used to record the user interface.

An additional development consists in the processor unit being set up in such a way that a recording of a movement or of a lingering of the interaction component, in particular of a hand or of a finger of the user, on the projection surface can be interpreted as the functionality of an input pointer.

In particular, a graphical user interface is projected onto the interaction surface. The camera records the user interface. If the interaction component, e.g. hand or finger of the user, is placed over the user interface, then the interaction component is recorded and, depending on its position, a function displayed on the user interface is initiated by the processor unit. In other words, the interaction component on the user interface represents the functionality of an input pointer, in particular of a (computer) mouse pointer. A trigger event (in the analogous example with the computer mouse: click or double click) may be, in particular, a lingering of the interaction component for a predetermined time duration at the position associated with the function.

In order to enable an improved identification performance of the interaction component on the interaction surface (in the example: on the user interface), the interaction surface can be illuminated with infrared light. The recording camera can be set up in such a way that it is (particularly) sensitive to the spectral region of the infrared light.

This results in an increased insensitivity to the influence of extraneous light.

In particular, the configuration described is suitable for use in a virtual touch screen or in a video telephone. In this case, the video telephone may also be a special application of the virtual touch screen.

One refinement consists in the projection surface (interaction surface) being embodied as a flat loudspeaker.

In accordance with an added feature of the invention, a further camera is provided for recording the user interface.

Other features which are considered as characteristic for the invention are set forth in the appended claims.

Although the invention is illustrated and described herein as embodied in an interaction configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is an illustration of an interaction configuration according to the invention;

FIG. 2 is a block diagram of a processor unit.

### DESCRIPTION OF THE PREFERRED EMBODIMENTS

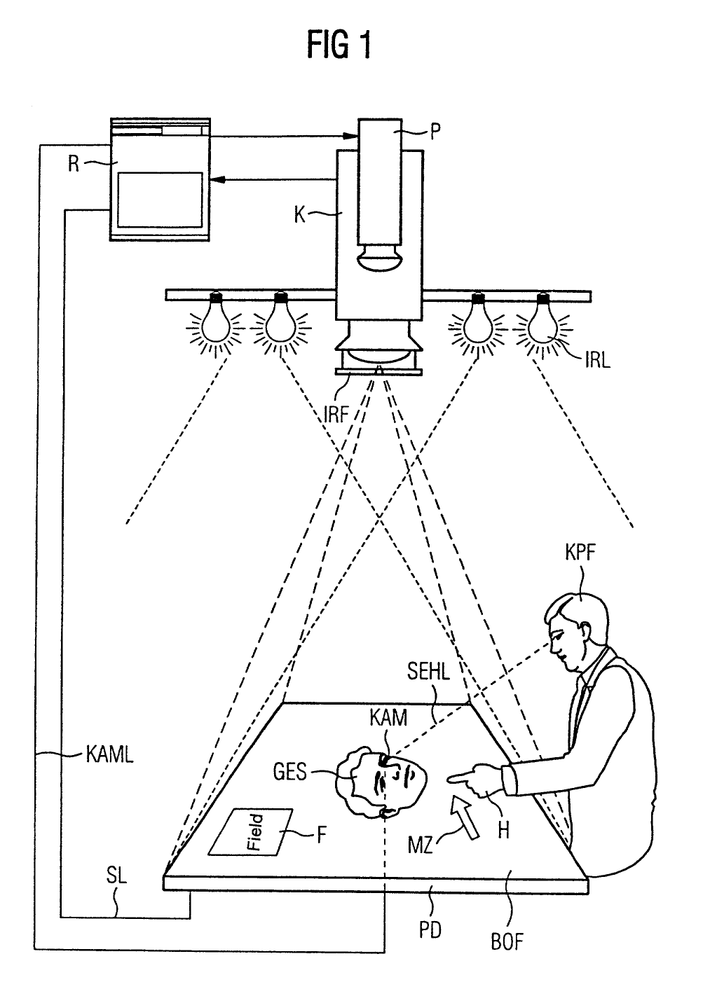

In all the figures of the drawing, sub-features and integral parts that correspond to one another bear the same reference symbol in each case. Referring now to the figures of the drawing in detail and first, particularly, to FIG. 1 thereof, there is shown a configuration of a virtual touch screen. An interaction surface (graphical user interface BOF) is projected onto a predeterminable region, in this case a projection display PD (interaction surface). The projection display PD in this case replaces a conventional screen. Inputting is effected by direct pointing with the interaction component, a hand H, at the user interface BOF. Therefore it is possible, for example, to replace a keyboard, a mouse, a touch screen or a digitizing tablet of conventional systems. The identification of the gestures and the positioning within the user interface BOF are realized by a video-based system (a gesture computer) which can identify and track the projection and form e.g. of the human hand in real time. Furthermore, the projection display PD is illuminated with infrared light in FIG. 1. An infrared light source IRL may advantageously be formed by infrared light-emitting diodes. A camera K, which is preferably configured with a special infrared filter IRF that is sensitive in the infrared spectral region, records the projection display PD. A projector P, which is controlled by a computer R, projects the user interface BOF onto the projection display PD. In this case, the user interface BOF may be configured as a menu system on a monitor of the computer R. A mouse pointer MZ is moved by the hand H of the user. Instead of the hand H, a pointer can also be used as an interaction component.

If the function associated with the actuation of a field F is intended to be called up on the user interface BOF, then the hand H is moved to the field F, the mouse pointer MZ following the hand H in the process. If the hand H remains above the field F for a predeterminable time duration, then the function associated with the field F is initiated on the computer R.

The projection display PD is preferably embodied as a flat loudspeaker, with the result that a sound evolution propagates from the surface of the user interface. The flat loudspeaker is driven by the computer R by a control line SL.

A service “video telephony” is represented in the example of FIG. 1; a user KPF converses with a representation of his addressee GES. In this case, the user KPF looks at the representation and makes virtual eye contact with the addressee GES (indicated by the viewing line SEHL). By use of a viewing camera KAM situated in the projection surface, preferably in the image of the face of the addressee GES, the user KPF is recorded head on and the recording is transmitted to the addressee GES. To that end, the image of the user KPF is preferably transmitted by a camera line KAML into the computer R and from there e.g. via a telephone line to the addressee GES. The two participants, both the user KPF and the addressee GES, thus have the impression, with realization of the service “video telephony,” that they are in direct eye contact with one another.

In particular, it is advantageous if a dark field (spot) essentially corresponding to the size of the objective diameter of the viewing camera KAM is projected onto the location of the viewing camera KAM by use of the projector P. This enables the recording of the user KPF to be transmitted in a high-quality manner and with reduced interference.

As an alternative, instead of the viewing camera KAM, it is possible to provide a plurality of such cameras. It is also possible to use software to detect the face of the addressee GES and to project the face into the surroundings of the viewing camera KAM. In this case, the viewing camera KAM is preferably embodied as a miniature camera having a small diameter.

It shall be noted here that the words “the viewing camera KAM is disposed in the projection surface” mean the entire projection surface including the edge of the projection.

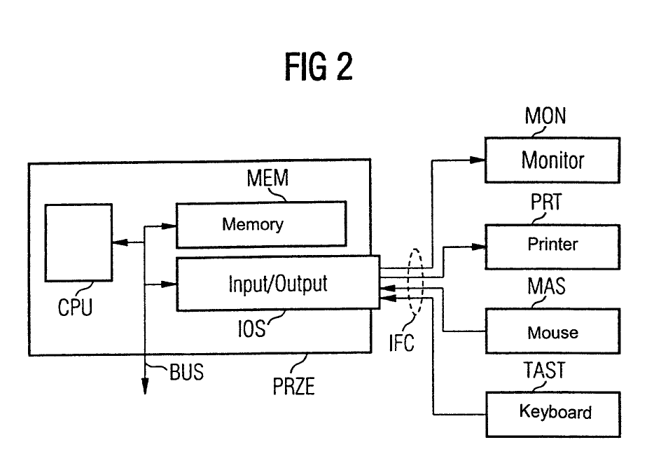

FIG. 2 illustrates a processor unit PRZE. The processor unit PRZE contains a processor CPU, a memory MEM and an input/output interface IOS, which is utilized via an interface IFC in different ways: via a graphics interface, an output is displayed on a monitor MON and/or is output on a printer PRT. An input is effected via a mouse MAS or a keyboard TAST. The processor unit PRZE also has a data bus BUS, which ensures the connection of a memory MEM, the processor CPU and the input/output interface IOS.

Furthermore, additional components can be connected to the data bus BUS, e.g. additional memory, data storage device (hard disk) or scanner.

I claim:

1. An interaction configuration, comprising:
a projection surface disposed such that said projection surface is visible to a user;
a camera for recording an image of the user and disposed in said projection surface; and
a processor unit set up for detecting and recording a movement or a lingering of an interaction component on said projection surface, the movement or the lingering of the interaction component is interpreted as an input pointer.

2. The configuration according to claim 1, wherein said projection surface is configured such that an addressee can be displayed on said projection surface.

3. The configuration according to claim 1, wherein said processor unit is set up such that a use r interface can be displayed on said projection surface.

4. The configuration according to claim 3, including a further camera for recording the user interface.

5. The configuration according to claim 1, wherein said projection surface is a flat loudspeaker.

6. The configuration according to claim 1, wherein said camera has an objective and is disposed at a camera location, a dark spot encompassing at least said objective of said camera is projected onto the camera location.

7. A virtual touch screen, comprising:
a interaction configuration, including:
a projection surface disposed such that said projection surface is visible to a user;
a camera for recording an image of the user and disposed in said projection surface; and
a processor unit set up for detecting and recording a movement or a lingering of an interaction component on said projection surface, the movement or the lingering of the interaction component is interpreted as an input pointer.

8. A video telephone, comprising:
a interaction configuration, including:
a projection surface disposed such that said projection surface is visible to a user;
a camera for recording an image of the user and disposed in said projection surface; and
a processor unit set up for detecting and recording a movement or a lingering of an interaction component on said projection surface, the movement or the lingering of the interaction component is interpreted as an input pointer.
